(19) United States
(12) Patent Application Publication
(10) Pub. No.: US 2026/0222445 A1
(43) Pub. Date: Jul. 30, 2026

(54) MULTI-FACTOR ANTI-PHISHING SYSTEMS AND METHODS

(71) Applicant: Dashlane SAS, Paris (FR)

(72) Inventors: Kaouther Ouenniche, Evry (FR); Guillaume Maron, Paris (FR); Frederic Rivain, Brooklyn, NY (US)

(73) Assignee: Dashlane SAS, Paris (FR)

(21) Appl. No.: 19/454,841

(22) Filed: Jan. 21, 2026

Related U.S. Application Data
(60) Provisional application No. 63/749,081, filed on Jan. 24, 2025.

(51) Int. Cl. H04L 9/40; G06N 20/00

(52) U.S. Cl. CPC H04L 63/1483; G06N 20/00; H04L 63/0428

(57) ABSTRACT

The present application describes a multi-factor anti-phishing system and method, featuring real-time local analysis of webpages on user devices. The system comprises a feature extraction system integrated with a web browser to extract a comprehensive set of features from visited webpages. These features include URL and host characteristics, content and structure indicators, resource files and scripts, form and action elements, and embedded media analysis. A machine learning (ML) model, trained on these features, analyzes the extracted data to predict phishing risks. The system uses a cloud secure enclave to manage allow lists and block lists, process encrypted feedback, and retrain the ML model, such that sensitive information remains confidential. The retrained ML model is periodically distributed to user devices to enhance phishing detection capabilities.

### CROSS-REFERENCE TO RELATED APPLICATIONS

This application claims the benefit of U.S. Provisional Patent Application No. 63/749,081, filed on Jan. 24, 2025, the entire contents of which are incorporated herein by reference.

### BACKGROUND

Phishing attacks continue to be a significant cybersecurity threat, predominantly exploiting user trust to harvest sensitive information through deceptive websites. Traditional anti-phishing solutions largely focus on filtering phishing attempts at the email level, leaving a significant gap in detecting phishing attacks that occur directly on webpages when phishing emails are not detected or when such webpages are visited not through an email link. It is with respect to this general technical environment that aspects of the present application are directed.

### SUMMARY

The present application describes multi-factor anti-phishing systems and methods.

For example, aspects of the present application include a method, comprising: receiving, at a user device, a webpage; extracting, by a feature extraction system at the user device, a set of features from the webpage and generating a feature vector based on the set of features; providing the feature vector to a local machine-learning (ML) model; outputting, by the ML model, a prediction whether the webpage represents a phishing attempt; receiving, through a user interface of the user device, user feedback indicating whether the prediction is accurate; and providing at least the user feedback and the feature vector to a cloud secure enclave.

In some examples, the method further comprises providing content and metadata for the webpage to the cloud secure enclave in addition to the user feedback and the feature vector. In some examples, the ML model is hosted on the user device. In some examples, the method further comprises: encrypting the user feedback and the feature vector before providing the user feedback and the feature vector to the cloud secure enclave. In some examples, the method further comprises receiving, from the cloud secure enclave, a retrained ML model based on the user feedback and the feature vectors. In some examples, the method further comprises: receiving, from the cloud secure enclave, an adapted feature extraction system. In some examples, the user interface provides an option for the user to report false negatives and false positives of the prediction.

In some other examples, aspects of the present application include a method, comprising: receiving, at a user device, a webpage; extracting, by a feature extraction system at the user device, a set of features from the webpage; generating a feature vector based on the set of features; providing the feature vector to a machine-learning (ML) model; outputting, by the ML model, a prediction of whether the webpage represents a phishing attempt; receiving, via a user interface, user feedback indicating whether the prediction is accurate; providing the user feedback and the feature vector to a cloud secure enclave; and receiving, from the cloud secure enclave, an update to the feature extraction system at the user device.

In some examples, the ML model is hosted on the user device. In some examples, the set of features extracted from the webpage includes at least one of URL characteristics, content indicators, link characteristics, form elements, or resource files. In some examples, the user interface provides an option for the user to report false negatives and false positives of the prediction. In some examples, the feature vector does not include any personally identifiable information. In some examples, the method further comprises removing personally identifiable information from the user feedback prior to providing the user feedback to the cloud secure enclave. In some examples, the method further comprises: encrypting the feedback and the feature vector before providing the feedback and the feature vector to the cloud secure enclave. In some examples, the method further comprises periodically receiving, from the cloud secure enclave, a retrained version of the ML model on the user device.

In some other examples, aspects of the present application include a user device, comprising: at least one processor; and memory, operatively connected to the at least one processor and storing executable instructions that, when executed, cause the at least one processor to perform operations, the operations comprising: receiving a webpage; extracting, by a feature extraction system at the user device, a set of features from the webpage and generating a feature vector based on the set of features; providing the feature vector to a machine-learning (ML) model; outputting, by the ML model, a prediction whether the webpage represents a phishing attempt; receiving, through a user interface, user feedback indicating whether the prediction is correct; and providing at least the user feedback and the feature vector to a cloud secure enclave.

In some examples, the ML model is hosted on the user device. In some examples, the operations further comprise: encrypting the user feedback and the feature vector before providing the user feedback and the feature vector to the cloud secure enclave. In some examples, the operations further comprise: receiving, from the cloud secure enclave, a retrained ML model based on the user feedback and the feature vector. In some examples, the operations further comprise: receiving, from the cloud secure enclave, an adapted feature extraction system.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram depicting an example system according to aspects of the present application.

FIG. 2 is a method flow depicting an example method according to aspects of the present application.

FIG. 3 is a method flow depicting an example method according to aspects of the present application.

FIG. 4 is a method flow depicting another example method according to aspects of the present application.

FIG. 5 is a block diagram depicting an example computing environment in which systems and methods of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. In addition, all systems described with respect to the Figures can comprise one or more machines or devices that are operatively connected to cooperate in order to provide the described system functionality. The following detailed description is therefore not to be taken in a limiting sense, and the scope of the present disclosure is defined by the appended claims and their equivalents.

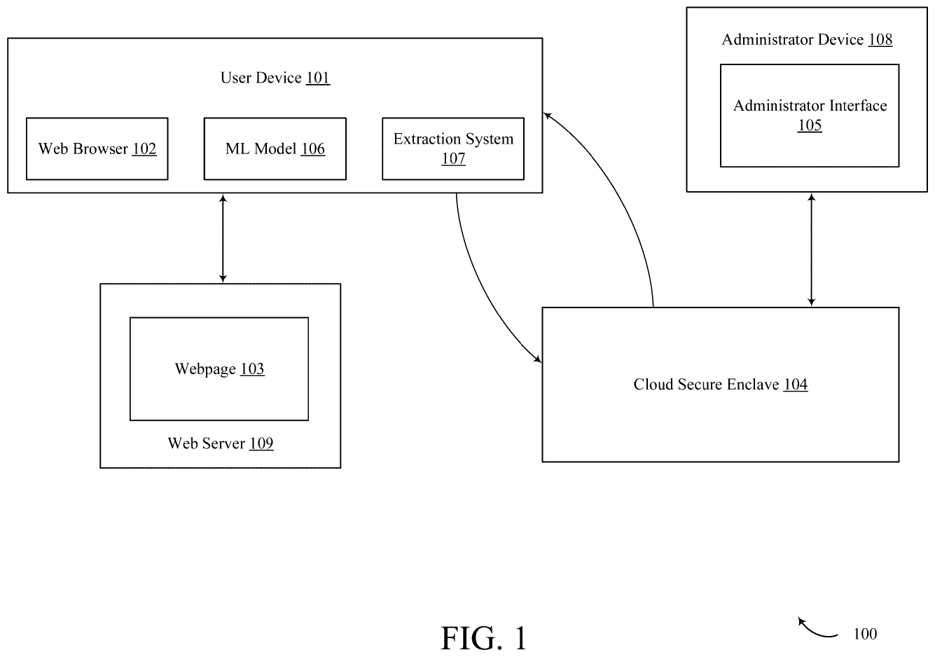

FIG. 1 depicts an example system 100 according to aspects of the present disclosure. Components of system 100 work to detect phishing attempts, for example, on webpages. System 100 includes user device 101, web browser 102, webpage 103, cloud secure enclave 104, administrator interface 105, ML model 106 (e.g., a local ML model), extraction system 107, administrator device 108, and web server 109.

User device 101 may be a computing device, such as a laptop computer, desktop computer, mobile phone, or tablet, and includes a machine learning (ML) model 106 and feature extraction system 107. User device 101 may (as depicted) store a copy of ML model 106 locally and may host web browser 102 and feature extraction system 107. In other examples, ML model 106 may be stored on one or more machines that are connected via a local area network (e.g., a customer local area network) to one or more user device 101 that are part of the same organization. For example, the ML model 106 may be shared among multiple user devices 101 that are all part of the same organization (and subject to the same browsing policies, among other examples). In still other examples, the ML model 106 may be stored on a separate network. User device 101 performs analysis (e.g., real-time analysis) of webpages that are rendered by the web browser 102, such as webpage 103, to detect phishing attempts. Webpage 103 (or the components thereof, such as the code used by the web browser 102 to build and render the webpage 103) may be downloaded, e.g., by web browser 102, from web server 109. Feature extraction system 107, which may be implemented as a web browser extension, receives or collects some or all data received by web browser 102, including metadata, and extracts various features from webpage 103 when it is downloaded, built, and/or rendered by browser 102. Feature extraction system 107 generates a feature vector based on the extracted features. ML model 106 then analyzes the feature vector to predict whether webpage 103 represents a phishing attempt. In examples, web browser 102 may display one or more warnings, may redirect to a safe webpage(s), and/or may collect user feedback to improve ML model 106.

User device 101 may include a feature extraction system 107 that may extract various features from webpage 103. These features may include URL length and composition, IP address and special characters (e.g., that are often used in phishing URLs), subdomain and top-level domain (TLD) analysis, HTTPS usage (e.g., whether HTTPS is used), and/or digit ratios. Digit ratios refer to the proportion of numerical characters within a URL. Feature extraction system 107 may additionally evaluate, receive, or collect webpage 103 content length, title and meta tags, and/or the complexity and depth of the Document Object Model (DOM) structure of the webpage 103. Additionally or alternatively, feature extraction system 107 may identify, receive, or collect hidden and null links, JavaScript-based links, and/or the ratio of external to internal links of webpage 103.

Feature extraction system 107 on user device 101 may analyze resource files and scripts, including Cascading Style Sheets (CSS) and script files of webpage 103. For example, feature extraction system 107 may detect suspicious scripts that may be obfuscated or encoded to hide phishing mechanisms. Feature extraction system 107 may examine input fields of webpage 103 for types commonly used to capture sensitive data, such as password and/or credit card fields. Feature extraction system 107 may also determine if form submissions are configured to be sent to external or suspicious URLs and may identify the presence and properties of login forms.

In examples, the features extracted by feature extraction system 107 from webpage 103 are compiled, by the user device 101/feature extraction system 107, into a structured format known as a feature vector. When webpage 103 is downloaded, built, and/or rendered by web browser 102, feature extraction system 107 may generate the feature vector based on the webpage 103. This feature vector represents the various attributes and characteristics of webpage 103 that are relevant for phishing detection. In examples, the generation of the feature vector by the extraction system 107 involves aggregating the extracted features into a numerical or categorical representation that can be interpreted by the ML model 106.

User device 101 may include an ML model 106 that may interpret the feature vector generated by feature extraction system 107. The ML model 106 may receive the feature vector without labels. In examples, ML model 106 interprets the feature vector to make a prediction about whether webpage 103 represents a phishing attempt. User device 101 may then take action, such as displaying a warning in the user interface of web browser 102 or redirecting web browser 102 to a safe webpage. User device 101 may also display a user interface element that allows the user to provide feedback on the prediction's accuracy as user feedback data.

The ML model 106 may be initially or periodically trained and updated on a dataset of phishing and non-phishing webpages, which serves as training data. As discussed later, the ML model 106 may be received initially, and updates be received periodically, from cloud secure enclave 104. In examples, the initial and/or continuous training of the ML model 106 may be performed at cloud secure enclave 104. The training data may include one or more feature vectors, with target labels (e.g., with features of, or the entirety of, the feature vector labeled as representative of phishing or non-phishing to facilitate training or retraining). ML model 106, trained on a set of features extracted from webpages, may predict whether webpage 103 represents a phishing attempt. ML model 106 may be trained using traditional machine learning algorithms, such as decision trees, support vector machines, and/or neural networks. In other examples, ML model 106 may use a deep learning approach, where feature extraction may be performed automatically by a neural network through the layers of the neural network. In addition, data collection and user feedback mechanisms may be realized within the cloud secure enclave 104. For example, users of multiple user devices 101 can securely report false positives and negatives, contributing to the continuous improvement of the ML model 106 by providing feature vectors and/or webpages to be used for future training of the model. Feedback may be received through any suitable means, such as via a user-interface element displayed within the web browser 102. If user feedback is received at the user device 101, the feedback (e.g., false positive, false negative), the feature vector extracted for that webpage 103 by the feature extraction system 107, and/or a full set of data (e.g., content and metadata) for the webpage 103 that was received by the feature extraction system 107 may be provided back to the cloud secure enclave 104 to allow for training and/or retraining of the ML model 106. By providing to the cloud secure enclave 104 information of the webpage relevant to the user feedback (e.g., rather than only the extracted feature vector), the feature extraction system 107 may also be retrained with new feature-extraction logic, for example. The generation of the feature vector may be reengineered in this way, while adding to the training data that can be used in retraining the ML model 106. The user feedback (e.g., indicating phishing/not phishing) may be used as labeled training data in the retraining of the ML model 106 at the cloud secure enclave 104 based on the feature vector as was used by the device that generated the user feedback, or the full webpage 103 based on a reengineered feature vector module. The ML model 106 may be updated periodically (e.g., during non-peak bandwidth times) so that the ML model 106 can benefit from the feature vectors and user feedback received by cloud secure enclave 104 from multiple user devices 101.

User device 101 (e.g., the extraction system 107) may also be configured to strip personally identifiable information and confidential content from the user feedback data and/or the training data. This may help ensure that sensitive information remains confidential and is not exposed during data collection and model retraining processes.

User device 101 may periodically receive updates to ML model 106 from cloud secure enclave 104, as will be described later. These updates may incorporate user feedback and new training data to improve the accuracy of phishing detection. User device 101 may ensure that the updated ML model 106 is deployed and operational for real-time analysis of webpages. Similarly, cloud secure enclave 104 may periodically update the code/logic of the extraction system 107, e.g., if additional features relevant to phishing detection are identified.

Web browser 102 may comprise an application used to access information on the Internet or other network. In examples, web browser 102 receives or accesses data that comprises webpage 103. Web browser 102 may be implemented on, hosted by, and/or displayed on user device 101. In examples, web browser 102 receives HTML, CSS, JavaScript, and/or other code for webpage 103 from web server 109, which is used to build and render webpage 103 on web browser 102. Web browser 102 integrates with and/or further comprises feature extraction system 107, which receives and collects some or all of the data received or accessed by web browser 102 to build and/or render webpage 103 to detect phishing indicators.

In examples, feature extraction system 107 may simply extract data from the content and/or metadata of webpage 103 or it may perform a certain amount of analysis of such data to generate a feature vector for interpretation by ML model 106. Among other examples, feature extraction system 107 may analyze the length of the URL and the presence of unusual patterns or characters that may indicate obfuscation. Feature extraction system 107 may detect URLs using Internet Protocol (IP) addresses instead of domain names and may count special characters often used in phishing URLs. Feature extraction system 107 may identify suspicious subdomains and top-level domains (TLDs) that deviate from standard practices. Feature extraction system 107 may detect the use of secure protocols by webpage 103 and may evaluate the proportion of numerical characters in the URL. Feature extraction system 107 may evaluate the amount of textual content on webpage 103, as phishing sites often have minimal content. Feature extraction system 107 may check for missing or misleading title and meta description tags. Feature extraction system 107 may analyze the complexity and depth of the DOM structure, which may be used to identify anomalies. Feature extraction system 107 may identify hidden and null links that are invisible to the user or have empty targets. Feature extraction system 107 may detect links that execute scripts instead of navigating to a new page. Feature extraction system 107 may assess the proportion of links leading outside the domain, which may indicate malicious intent.

Feature extraction system 107 may analyze resource files and scripts, including Cascading Style Sheets (CSS) and script files. Feature extraction system 107 may determine the number and source of style sheets and scripts, including inline scripts that may contain malicious code. Feature extraction system 107 may detect obfuscated or encoded scripts that could hide phishing mechanisms. Feature extraction system 107 may analyze input fields for types commonly used to capture sensitive data, such as password and credit card fields. Feature extraction system 107 may determine if form submissions are sent to external or suspicious URLs and may identify the presence and properties of login forms.

Feature extraction system 107 may detect frames that may load content from external sources to mask malicious activities. Feature extraction system 107 may assess whether images are loaded from trusted sources or external domains. Feature extraction system 107 generates a feature vector for webpage 103 based on the analysis of the above data. User device 101 provides the feature vector to ML model 106, and the ML model 106 makes a prediction about whether webpage 103 represents a phishing risk, as will be described later.

Web browser 102 may display a warning in the user interface if ML model 106 predicts that webpage 103 represents a phishing attempt. Web browser 102 may redirect the user to (or automatically access) a safe webpage if a phishing attempt is detected. Web browser 102 may provide a user interface element that allows the user to provide feedback on the accuracy of the phishing detection. Web browser 102 may collect user feedback and provide the user feedback to cloud secure enclave 104 for retraining ML model 106.

Web browser 102 may periodically, or after a threshold amount of received user feedback as described later, receive updates to ML model 106 from cloud secure enclave 104. These updates may incorporate user feedback and new training data to improve the accuracy of phishing detection. Web browser 102 may ensure that the updated ML model 106 is deployed and operational for real-time analysis of webpages.

Webpage 103, which may include documents, metadata, and/or code accessible through web browser 102/user device 101, may comprise content such as text, images, videos, and/or links to other pages or resources. In examples, when a user navigates to a URL for webpage 103, web browser 102 receives or accesses information comprising webpage 103 from web server 109, and then builds and renders the webpage 103 for display. As discussed, feature extraction system 107 on user device 101 analyzes the received or accessed information to generate a feature vector. ML model 106 then processes the feature vector to determine whether (e.g., a likelihood of) webpage 103 is malicious.

Cloud secure enclave 104, which may comprise a confidential computing system in a cloud computing environment, may be configured to process sensitive data securely and train/retrain ML model 106. In examples, cloud secure enclave 104 ensures that navigation data remains private and inaccessible to service providers, such as providers of anti-phishing services. In examples, navigation data refers to information related to the user's interactions and activity on user device 101 (e.g., which webpages 103 are being accessed by which user devices 101 and/or users of those user devices 101). Navigation data may include URLs visited, click patterns, browsing history, session data, and/or metadata. In examples, cloud secure enclave 104 receives encrypted feedback and data from user device 101, and the cloud secure enclave 104 updates and retrains ML model 106 based on encrypted user feedback and/or other data, such as a feature vector extracted by extraction system 107. The cloud secure enclave 104 periodically, or after a threshold amount of user feedback has been reached, distributes retrained ML model 106 to user device 101. The threshold of user feedback may be based on a number of user feedback responses, among other possibilities.

Cloud secure enclave 104 may include various features and functionalities to support the detection of phishing attempts and the protection of sensitive data. Cloud secure enclave 104 may integrate advanced machine learning techniques with confidential computing technology to process sensitive data securely. Cloud secure enclave 104 may receive encrypted feedback and data from a plurality of user devices 101, which may be used to update and retrain ML model 106.

Cloud secure enclave 104 may also manage a static, large-scale allow list of trusted domains as a foundational reference. Cloud secure enclave 104 may also manage a static block list of untrusted domains. An organizational-level allow list (or block list) may be managed and protected within cloud secure enclave 104. In examples, URLs and user data are neither stored nor transmitted in plain text, ensuring that sensitive information remains confidential, even to the service provider operating the anti-phishing service. Administrators of user devices 101 may define and manage trusted domains (or untrusted domains) specific to their organization within cloud secure enclave 104, enforcing security policies without exposing URL data.

Cloud secure enclave 104 may distribute, to the user device 101, the allow list of trusted domains (and/or block list of untrusted domains) (e.g., along with the ML model 106) based on the organization to which user device 101 is registered at the service provider. The feature extraction system 107 (e.g., user device 101) may identify the trusted domains of the allow list and/or untrusted domains of the block list. Any URLs on the allow list provided to user device 101 may be ignored by feature extraction system 107 or user device 101 to reduce false positives and save unnecessary usage of computing resources. Similarly, any URLs on the block list provided to user device 101 may be tagged directly (e.g., by the user device 101 or feature extraction system 107) as phishing without further analysis.

Cloud secure enclave 104 may also implement data collection and user feedback mechanisms. Users may securely report false positives and negatives, contributing to the continuous improvement of ML model 106 by sending feature vectors and/or webpages to be used for future training of ML model 106. Feedback may be received through any suitable means, such as via a user-interface element displayed within web browser 102. If user feedback is received at user device 101, the feedback (e.g., false positive, false negative), the feature vector extracted for that webpage 103 by feature extraction system 107, and a full set of data (content and metadata) for webpage 103 that was received by feature extraction system 107 may be provided back to cloud secure enclave 104 to allow for retraining of ML model 106. For example, the user feedback (e.g., indicating phishing/not phishing) can now be used as labeled training data in the retraining of the ML model 106 at the cloud secure enclave 104 based either on: (a) the feature vector as was used by the user device 101 that generated the user feedback or (b) the full webpage 103 based on a reengineered feature extraction system that is then provided to the user device 101.

Cloud secure enclave 104 may process user feedback confidentially, allowing ML model 106 to be retrained without high risk of compromising user or organizational privacy. User feedback (e.g., all user feedback) (including the feature vector and/or webpage information) may be encrypted when provided from user device 101 to cloud secure enclave 104. When received by cloud secure enclave 104, the data may be encrypted with a key that is accessible by cloud secure enclave 104 through (e.g., only through) a key management system (KMS). The integration of confidential computing for data collection and model training may uphold a zero-knowledge architecture, where sensitive data remains protected throughout the process.

Cloud secure enclave 104 may periodically distribute the retrained ML model 106 to user device(s) 101. Multiple user devices, or devices for multiple organizations that represent multiple users, may provide user feedback to cloud secure enclave 104 and receive a same or similar (e.g., updated) ML model 106 for use on user devices 101. The allow list for individual users and/or individual organizations may be specific to such individual users or devices or organizations.

If not already removed by extraction system 107 when generating the feature vectors, cloud secure enclave 104 may include a sensitive data removal component that strips personally identifiable information and confidential content from both user feedback data and training data, further safeguarding user privacy. Cloud secure enclave 104 may ensure that sensitive information remains confidential and is not exposed during data collection and model retraining processes.

Administrator interface 105, a tool used by administrators and which may be hosted on administrator device 108, manages policies related to the system's operation. Administrator interface 105 may comprise a user interface to configure settings, monitor performance, and ensure compliance with security protocols. Administrators may use administrator interface 105 to define and manage trusted domains (allow lists) and untrusted domains (block lists) within cloud secure enclave 104. Administrator interface 105 provides a secure way to enforce organizational security policies without exposing navigational data. Administrators may also monitor the performance of the anti-phishing system and make adjustments to improve detection accuracy and user privacy.

Administrators may use administrator interface 105 to manage the allow list of trusted domains and the block list of untrusted domains specific to their organization within cloud secure enclave 104. Administrator interface 105 may ensure that URLs and user data are neither stored nor transmitted in plain text, maintaining the confidentiality of sensitive information.

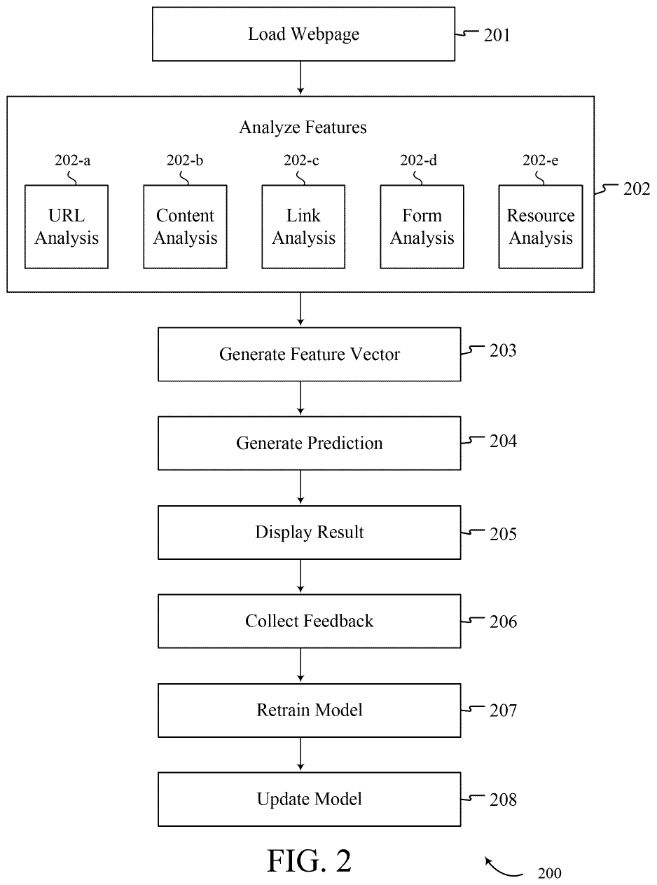

FIG. 2 illustrates an example method 200 in accordance with the present application. In examples, some or all of the operations of method 200 are performed by one or more components of system 100. It should be understood that the sequence of operations of the method is not fixed, but can be modified, changed in order, performed differently, performed sequentially, concurrently, or simultaneously, or altered into any desired sequence, as recognized by a person of skill in the art. In some examples, certain operations depicted in the method 200 may be omitted, and in certain examples, other operations may be added.

At operation 201, a webpage may be loaded at a user device. For example, the user device 101 may load webpage 103. For example, web browser 102 may retrieve the webpage 103 from a web server 109 and display the webpage 103 on user device 101. Web browser 102 may process HTML, CSS, JavaScript, and/or other web technologies to render the content of the webpage 103 for display. User device 101, via web browser 102, may display the elements of the webpage 103 to the user.

At operation 202, features of a webpage (such as content and/or metadata) may be analyzed. For example, the user device 101 (e.g., feature extraction system 107) may analyze features of webpage 103, as described in operations 202-a to 202-e.

At operation 202-a, a URL analysis may be performed. For example, the user device 101 (e.g., feature extraction system 107) may analyze the URL of the webpage 103. Feature extraction system 107 may analyze the length of the URL and the presence of unusual patterns or characters that may indicate obfuscation. Feature extraction system 107 may detect URLs using Internet Protocol (IP) addresses instead of domain names and may count special characters often used in phishing URLs. Feature extraction system 107 may identify suspicious subdomains and top-level domains (TLDs) that deviate from standard practices. Feature extraction system 107 may detect the use of secure protocols by the webpage and may evaluate the proportion of numerical characters in the URL.

At operation 202-b, content analysis of the webpage may be performed. For example, the user device 101 (e.g., feature extraction system 107) may analyze the content of the webpage 103. Feature extraction system 107 may evaluate the amount of textual content on the webpage, as phishing sites often have minimal content. Feature extraction system 107 may check for missing or misleading title and meta description tags. Feature extraction system 107 may analyze the complexity and depth of the DOM structure, which may be used to identify anomalies.

At operation 202-c, link analysis may be performed. For example, the user device 101 (e.g., feature extraction system 107) may analyze the link of the webpage 103 and/or links included in the webpage 103. Feature extraction system 107 may identify hidden and null links that are invisible to the user or have empty targets. Feature extraction system 107 may detect links that execute scripts instead of navigating to a new page. Feature extraction system 107 may assess the proportion of links leading outside the domain, which may indicate malicious intent.

At operation 202-d, analysis of forms and fields may be performed. For example, the user device 101 (e.g., feature extraction system 107) may analyze the forms and/or input fields on the webpage 103. User device 101 (e.g., feature extraction system 107) may identify input fields for types commonly used to capture sensitive data, such as password and credit card fields. Feature extraction system 107 may determine if form submissions are sent to external or suspicious URLs and may identify the presence and/or properties of login forms.

At operation 202-e, analysis of resource files and/or scripts may be performed. For example, the user device 101 (e.g., feature extraction system 107) may analyze the resource files and/or scripts on the webpage 103. User device 101 (e.g., feature extraction system 107) may determine the number and source of style sheets and scripts, including inline scripts that may contain malicious code. Feature extraction system 107 may detect obfuscated or encoded scripts that could hide phishing mechanisms. Feature extraction system 107 may detect iframes that may load content from external sources to mask malicious activities. Feature extraction system 107 may assess whether images are loaded from trusted sources or external domains.

At operation 203, a feature vector may be generated. For example, the user device 101 (e.g., feature extraction system 107) may generate a feature vector based on the analysis of the webpage 103. User device 101 (e.g., feature extraction system 107) may compile the results of the URL analysis, content analysis, link analysis, form analysis, and resource analysis into a feature vector. This feature vector may represent the characteristics of the webpage that are relevant to phishing detection.

At operation 204, a prediction may be made by the ML model whether the webpage is a phishing webpage. For example, the user device 101 (e.g., ML model 106) may make a prediction using the ML model. ML model 106 may analyze the feature vector generated by feature extraction system 107 and may predict whether the webpage represents a phishing attempt. ML model 106 may use traditional machine learning algorithms, such as decision trees, support vector machines, or gradient boosting machines, or may use a deep learning approach where feature extraction is performed automatically by a neural network through the layers of the neural network.

At operation 205, the user device 101 may display the phishing detection result. User device (e.g., web browser 102) may display a warning in the user interface if ML model 106 predicts that the webpage represents a phishing attempt. Web browser 102 may redirect the user to a safe webpage if a phishing attempt is detected.

At operation 206, the user device 101 may collect user feedback. Web browser 102 may provide a user interface element that allows the user to provide feedback on the accuracy of the phishing detection. The feedback may include whether the user agrees with the phishing detection result or if the user believes the result is a false positive or false negative.

At operation 207, the ML model may be retrained. For example, the cloud secure enclave 104 may retrain the ML model. Cloud secure enclave 104 may receive the user feedback, feature vectors, and webpage data from one or a plurality of user devices 101. Cloud secure enclave 104 may use this data to retrain ML model 106, improving accuracy and effectiveness in detecting phishing attempts.

At operation 208, the ML model may be updated (also referred to as “adapted”). For example, the user device 101 may receive an update to the ML model 106 (e.g., periodically and/or based on user feedback) from the cloud secure enclave 104. Cloud secure enclave 104 may retrain the ML model 106 and distribute the retrained ML model 106 to user device(s) 101 periodically, based on a threshold amount of user feedback, or based on another trigger. The updated ML models 106 may be retrained (adapted) based on user feedback and new training data to improve the accuracy of phishing detection. User devices 101 may check that the updated ML model 106 is deployed and operational for real-time analysis of webpage(s) 103.

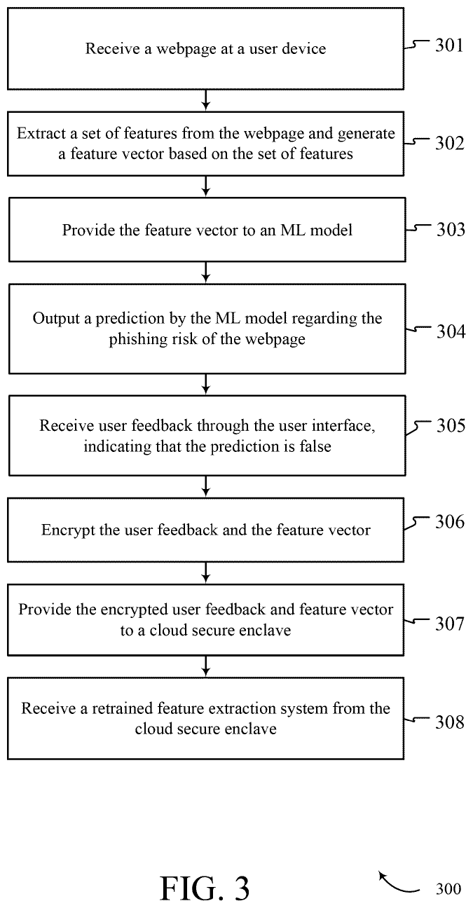

FIG. 3 illustrates an example method 300 in accordance with the present application. In examples, some or all of the operations of method 300 are performed by one or more components of system 100. It should be understood that the sequence of operations of the method is not fixed, but can be modified, changed in order, performed differently, performed sequentially, concurrently, or simultaneously, or altered into any desired sequence, as recognized by a person of skill in the art. In some examples, certain operations depicted in the method 300 may be omitted, and in certain examples, other operations may be added.

At operation 301, the method may include receiving a webpage at a user device. For example, web browser 102 may retrieve the webpage from a web server and display the webpage on user device 101. Web browser 102 may process HTML, CSS, JavaScript, and other web technologies to render the content of the webpage for display. Web browser 102 may ensure that all elements of the webpage are correctly loaded and displayed to the user.

At operation 302, the method may include extracting a set of features from the webpage and generating a feature vector based on the set of features. Feature extraction system 107 may analyze various aspects of the webpage, including URL characteristics, content structure, resource files, form elements, and embedded media.

At operation 303, the method may include providing the feature vector to a ML model. The ML model 106 may analyze the feature vector to predict whether the webpage represents a phishing attempt.

At operation 304, the method may include outputting a prediction by the ML model regarding the phishing risk of the webpage. The prediction may be displayed on a user interface of the user device, indicating whether the webpage is suspected of phishing.

At operation 305, the method may include receiving user feedback through the user interface, indicating that the prediction is false. The user may provide feedback to correct the prediction of the ML model 106.

At operation 306, the method may include encrypting the user feedback and the feature vector. The encryption ensures that sensitive information remains protected during transmission.

At operation 307, the method may include providing the encrypted user feedback and feature vector to a cloud secure enclave. The cloud secure enclave 104 processes the feedback and updates and retrains the ML model 106. Additionally, in some examples, the method may include providing content and metadata for the webpage to the cloud secure enclave in addition to the user feedback and the feature vector.

At operation 308, the method may include receiving an adapted feature extraction system from the cloud secure enclave. In some examples, this may include receiving a an ML model that has been retrained at the cloud secure enclave based on the user feedback and the feature vector.

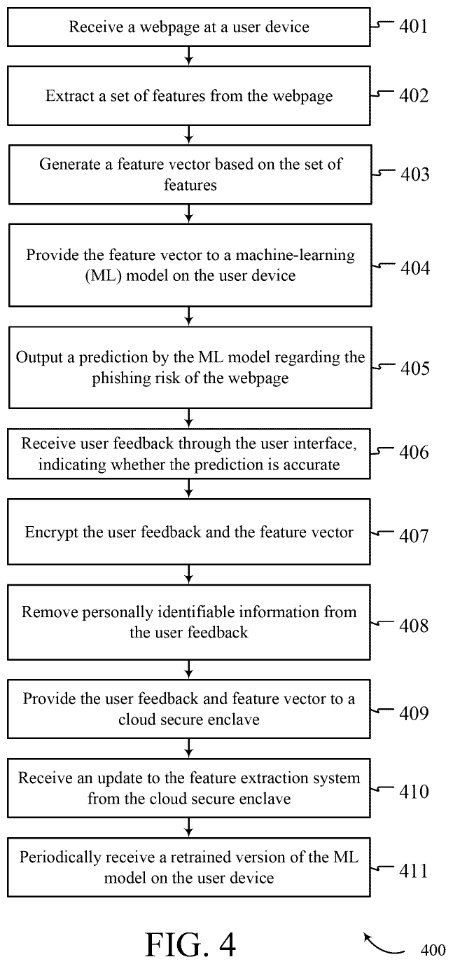

FIG. 4 illustrates an example method 400 in accordance with the present application. In examples, some or all of the operations of method 400 are performed by one or more components of system 100. It should be understood that the sequence of operations of the method is not fixed, but can be modified, changed in order, performed differently, performed sequentially, concurrently, or simultaneously, or altered into any desired sequence, as recognized by a person of skill in the art. In some examples, certain operations depicted in the method 400 may be omitted, and in certain examples, other operations may be added.

At operation 401, the method may include receiving a webpage at a user device. For example, web browser 102 may retrieve the webpage 103 from a web server and display the webpage 103 on user device 101. Web browser 102 may process HTML, CSS, JavaScript, and other web technologies to render the content of the webpage for display. Web browser 102 may ensure that all elements of the webpage are correctly loaded and displayed to the user.

At operation 402, the method may include extracting a set of features from the webpage. Feature extraction system 107 may analyze various aspects of the webpage 103, including URL characteristics, content indicators, link characteristics, form elements, and/or resource files.

At operation 403, the method may include generating a feature vector based on the set of features. The feature extraction system 107 may compile the extracted features into a structured format suitable for analysis by the ML model 106.

At operation 404, the method may include providing the feature vector to a local machine-learning (ML) model on the user device. The ML model 106 may analyze the feature vector to predict whether the webpage represents a phishing attempt.

At operation 405, the method may include outputting a prediction by the ML model regarding the phishing risk of the webpage. The prediction may be displayed on a user interface of the user device 101, indicating whether the webpage 103 is suspected of phishing.

At operation 406, the method may include receiving user feedback through the user interface, indicating whether the prediction is accurate. The user may provide feedback to confirm or correct the ML model's prediction.

At operation 407, the method may include encrypting the user feedback and the feature vector. The encryption ensures that sensitive information remains protected during transmission.

At operation 408, the method may include removing personally identifiable information from the user feedback.

At operation 409, the method may include providing the user feedback and feature vector to a cloud secure enclave. The cloud secure enclave 104 processes the feedback to update and retrain the ML model 106.

At operation 410, the method may include receiving an update to the feature extraction system from the cloud secure enclave.

At operation 411, the method may include periodically receiving a retrained version of the ML model on the user device.

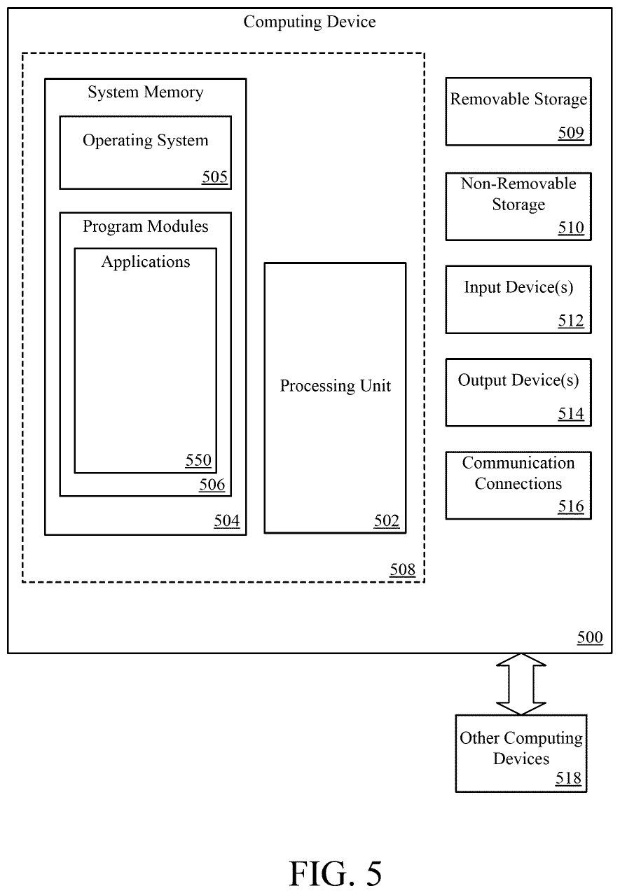

FIG. 5 is a block diagram illustrating an exemplary computer or system hardware architecture, in accordance with various embodiments. FIG. 5 provides a schematic illustration of one embodiment of a computer system 500 of the system hardware that can perform the methods provided by various other embodiments, as described herein, and/or can perform the functions of computer or hardware system (i.e., user devices, service provider devices, relying party devices, etc., as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which, in examples, represent an embodiment of the computer or hardware system described above with respect to earlier figures—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network, with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general-purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general-purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

As discussed, the computer system 500 may include one or more secure enclave(s). That is one or more of the resources (e.g., processor(s) 510, working memory 535, and/or application(s) 545, among other things) may be duplicated and/or allocated to one or more secure enclave(s) within computer system 500. In examples, a secure enclave may also be referred to as a trusted execution environment. The secure enclave may comprise a computing environment that provides isolation for code and data from the operating system 540 using either hardware-based isolation or isolating an entire virtual machine by placing the hypervisor within a trusted computing base. In examples, users with physical and/or root access to the computer system 500 and operating system 540 are prevented from accessing the contents of the secure enclave memory or tampering with the execution of code within the secure enclave. Nonexclusive, nonlimiting examples of secure enclaves are available for consumer electronics devices, computers/servers, data centers, etc., including from vendors such as Intel, AMD, and Amazon Web Services. Other examples of secure enclaves are possible and contemplated.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the present application.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with, or without, certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media may be non-transitory and tangible and does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, comprising:
receiving, at a user device, a webpage;
extracting, by a feature extraction system at the user device, a set of features from the webpage and generating a feature vector based on the set of features;
providing the feature vector to a machine-learning (ML) model;
outputting, by the ML model, a prediction whether the webpage represents a phishing attempt;
receiving, through a user interface of the user device, user feedback indicating whether the prediction is accurate; and
providing at least the user feedback and the feature vector to a cloud secure enclave.

2. The method of claim 1, further comprising providing content and metadata for the webpage to the cloud secure enclave in addition to the user feedback and the feature vector.

3. The method of claim 1, wherein the ML model is locally hosted on the user device.

4. The method of claim 1, further comprising:
encrypting the user feedback and the feature vector before providing the user feedback and the feature vector to the cloud secure enclave.

5. The method of claim 1, further comprising receiving, from the cloud secure enclave, a retrained ML model based on the user feedback and the feature vectors.

6. The method of claim 1, further comprising:
receiving, from the cloud secure enclave, an adapted feature extraction system.

7. The method of claim 1, wherein the user interface provides an option for the user to report false negatives and false positives of the prediction.

8. A method, comprising:
receiving, at a user device, a webpage;
extracting, by a feature extraction system at the user device, a set of features from the webpage;
generating a feature vector based on the set of features;
providing the feature vector to a machine-learning (ML) model;
outputting, by the ML model, a prediction of whether the webpage represents a phishing attempt;
receiving, via a user interface, user feedback indicating whether the prediction is accurate;
providing the user feedback and the feature vector to a cloud secure enclave; and
receiving, from the cloud secure enclave, an update to the feature extraction system at the user device.

9. The method of claim 8, wherein the ML model is hosted on the user device.

10. The method of claim 8, wherein the set of features extracted from the webpage includes at least one of URL characteristics, content indicators, link characteristics, form elements, or resource files.

11. The method of claim 8, wherein the user interface provides an option for the user to report false negatives and false positives of the prediction.

12. The method of claim 8, wherein the feature vector does not include any personally identifiable information.

13. The method of claim 8, further comprising removing personally identifiable information from the user feedback prior to providing the user feedback to the cloud secure enclave.

14. The method of claim 8, further comprising:
encrypting the feedback and the feature vector before providing the feedback and the feature vector to the cloud secure enclave.

15. The method of claim 8, further comprising periodically receiving, from the cloud secure enclave, a retrained version of the ML model on the user device.

16. A user device, comprising:
at least one processor; and
memory, operatively connected to the at least one processor and storing executable instructions that, when executed, cause the at least one processor to perform operations, the operations comprising:
receiving a webpage;
extracting, by a feature extraction system at the user device, a set of features from the webpage and generating a feature vector based on the set of features;
providing the feature vector to a machine-learning (ML) model;
outputting, by the ML model, a prediction whether the webpage represents a phishing attempt;
receiving, through a user interface, user feedback indicating whether the prediction is correct; and
providing at least the user feedback and the feature vector to a cloud secure enclave.

17. The user device of claim 16, wherein the ML model is locally hosted on the user device.

18. The user device of claim 16, the operations further comprising:
encrypting the user feedback and the feature vector before providing the user feedback and the feature vector to the cloud secure enclave.

19. The user device of claim 16, the operations further comprising:
receiving, from the cloud secure enclave, a retrained ML model based on the user feedback and the feature vector.

20. The user device of claim 16, the operations further comprising:
receiving, from the cloud secure enclave, an adapted feature extraction system.
